(19) United States
(12) Patent Application Publication
(10) Pub. No.: US 2003/0000989 A1
(43) Pub. Date: Jan. 2, 2003

(54) Feeding system for compressible materials

(76) Inventor: John S. Glinka, Mt. Prospect, IL (US)

Correspondence Address: William M. Lee, Jr., Lee, Mann, Smith, McWilliam, Sweeney & Ohlson, P.O. Box 2786, Chicago, IL, 60690-2786, US

(21) Appl. No.: 10/171,743

(22) Filed: Jun. 14, 2002

Related U.S. Application Data
(60) Provisional application No. 60/298,853, filed on Jun. 15, 2001.

(51) Int. Cl. B65G 25/00

(52) U.S. Cl. 226/177; 271/194; 198/518; 198/721; 198/722; 226/193

(57) ABSTRACT

A feeding system for difficult web and sheet materials, such as bubble wrap. A drive roller having a high friction surface is spaced over a flexible platen having a low friction transport surface. The gap between the platen and the drive roller is adjustable, and the drive roller is driven to advance web and sheet materials between the drive roller and the transport surface. The transport surface has a very low coefficient of static friction, and the surface of the drive roller has a very high coefficient of static friction, with the coefficients of friction differing by at least 0.5.

### RELATED APPLICATION

This application is the non-provisional filing of provisional U.S. Patent application serial No. 60/298,853 filed Jun. 15, 2001.

### BACKGROUND OF THE INVENTION

This invention relates to feeding of web and sheet materials, and in particular to feeding of difficult web and sheet materials, such as bubble wrap, which cannot be conveyed by conventional feeding systems.

Feed systems for advancing web and sheet materials typically a drive roller situated above or below a nip roller. Either or both of the rollers is driven, and typically the rollers can have similar surface characteristics, with the material being advanced by a combination of pressure between the rollers and the surface friction of the rollers.

Difficult materials, such as bubble wrap, foam products, layered cloth and paper, and materials with adhesive backing normally cannot be fed in conventional systems. Either the material becomes skewed when passing between the rollers, because the material is uneven in cross-section, or, if the gap between the rollers is set to be too small, at least part of the material can be damaged. It is the object of the invention to develop a feeding system which easily accommodates difficult materials, and feeds them satisfactorily and consistently for downstream processing.

### SUMMARY OF THE INVENTION

The invention is a feeding system for difficult web and sheet materials, and comprises a flexible platen having a low friction transport surface. A drive roller having a high friction surface is situated above and spaced from the transport surface, forming a gap. Means is provided for adjusting the gap, and means is also provided for operating the drive roller to advance sheet and other materials between the drive roller and the transport surface.

In accordance with the preferred form of the invention, the transport surface has a first coefficient of static friction and the high friction surface of the drive roller has a second coefficient of static friction. The coefficients of static friction differ by at least 0.5, and preferably by greater than at least 1.0. The transport surface has a coefficient of friction of from about 0.04 or less to about 0.25, therefore maintaining its low friction. The high friction surface has a coefficient of static friction of greater than about 0.75. To accommodate uniquely shaped materials, preferably the high friction surface is compressible in order to work in concert with the flexibility of the platen.

In accordance with the preferred form of the invention, the adjusting means comprises a screw adjustment. The screw adjustment comprises a pair of individually adjustable screws on opposite sides of the platen. The screws are mounted in the frame for the feeding system, and are engaged in a support for the platen.

Operation of the drive roller can be conventional, and is preferably a motor connected in the normal fashion. The motor can be computer controlled, and can be constructed to work in combination with upstream or downstream feeding and handling apparatus.

### BRIEF DESCRIPTION OF THE DRAWINGS

The invention is described in greater detail in the following description of an example embodying the best mode of the invention, taken in conjunction with the drawing figures, in which:

FIG. 1 is a partial perspective view of a feeding system according to the invention, with portions broken away to illustrate detail and with the majority of the frame of the feeding system being eliminated, and

FIG. 2 is a side elevational illustration of the primary elements of the invention as shown in FIG. 1, and schematically illustrating feeding of a difficult sheet material.

### DESCRIPTION OF AN EXAMPLE EMBODYING THE BEST MODE OF THE INVENTION

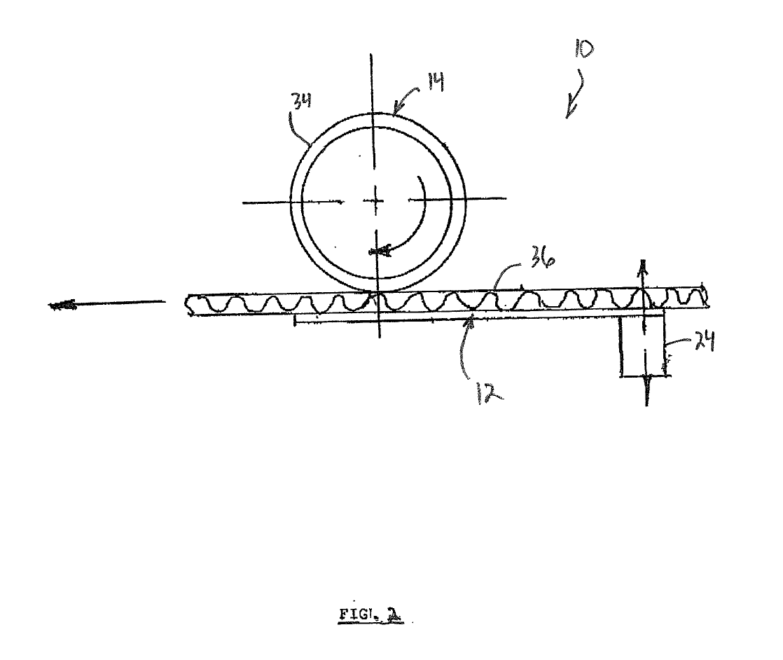

A feeding system according to the invention is depicted generally at 10 in the drawing figures. The feeding system 10 comprises a flexible platen 12 and a drive roller 14 spaced from the flexible platen 12, forming a gap between the platen 12 and the drive roller 14 as best shown in FIG. 2. The geometry of the platen 12 and the drive roller 14 can be reversed from that shown, as would be evident to one skilled in the art.

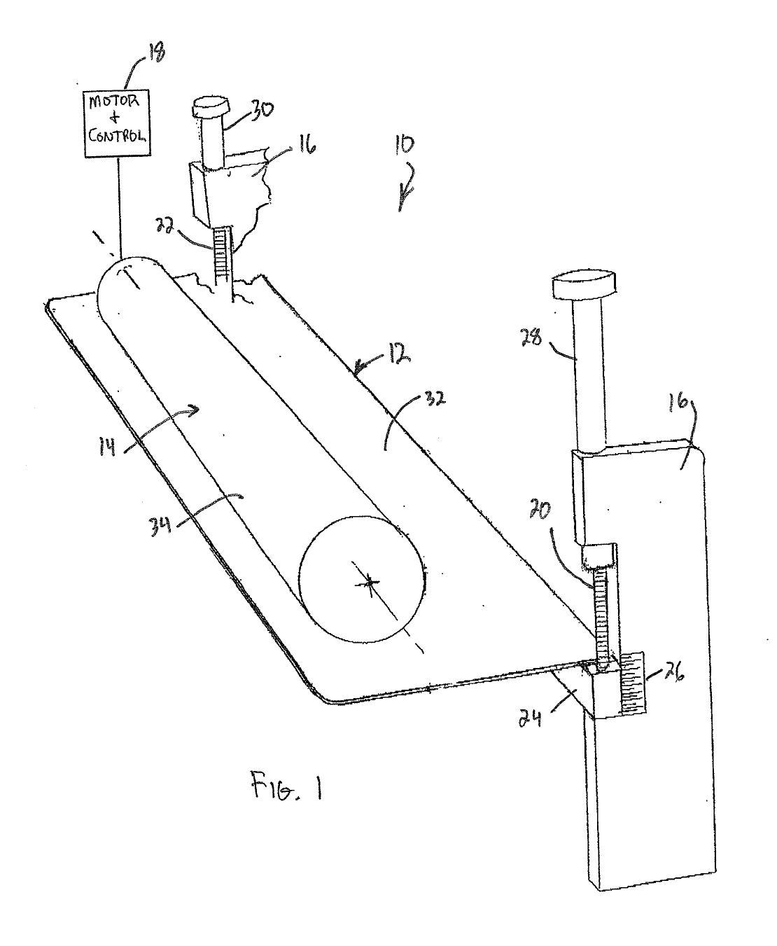

Both the platen 12 and the roller 14 are mounted in a frame 16, only two portions of which are shown in FIG. 1. The frame 16 can be made of steel, aluminum or any other material of sufficient strength to mount and hold the platen 12 and the roller 14 for their various functions, as described in greater detail below.

The drive roller 14 is driven by a motor 18, which can be conventional, and which can include conventional controls. The motor 18 can be self contained, or can be formed to be connectable to other feeding and handling apparatus in line with the feeding system 10. The type of the motor and its control, as well as its particular connection to the drive roller 14 are not part of the invention other than, of course, a motor is required for operating the drive roller 14.

The platen 12 is flexible, and is made of appropriate material to impart the flexibility herein described. The flexible platen 12 acts much like a spring, and is adjustable in relation to the roller 14 by means of a screw adjustment comprising a pair of individually adjustable screws 20 and 22 on opposite sides of the platen 12. The screws 20 and 22 engage a stiff platen support 24 extending beneath the platen 12 and the adjustment of the platen 12 in relation to the roller 14 can be visually sighted by means of a gage 26 on the frame 16. Adjustment of the screws 20 and 22 can be conventional, with respective manual adjustment knobs 28 and 30 being illustrated.

The flexible platen 12 has a transport surface 32 which is of particularly low friction. It preferably has a coefficient of static friction of from 0.04 or less, to 0.25, depending on the material being fed by the feeding system 10.

Conversely, the drive roller 14 has a high friction outer surface 34 which has a relatively high coefficient of static friction. That coefficient of static friction may range from 0.75 to far greater than 1.0.

The material of the transport surface 32 can vary, so long as it is of the low friction described and is durable. Materials such as ultra high molecular weight polyethylene, Teflon, nylon and the like can be employed. The material of the outer surface 34 of the drive roller 14 can be any of a variety of thin materials which have an adequate coefficient of static friction. This would include rubber, urethane, some plastics, and even materials such as leather. The material of the outer surface 34 of the drive roller 14 can also be compressible, to further accommodate any uneven nature of the material being fed by the feeding system 10.

The principle of the invention is based upon having high friction between the drive roller and the material 36 being fed, and, conversely, as low friction as possible between the flexible platen 12 and the material 36. The invention relies somewhat on the force of squeezing between the driver roller 14 and the flexible platen 12, and primarily on the frictional interface between the outer surface 34 of the drive roller 14 and the material 36.

With the coefficients of static friction of the transport surface 32 and the outer surface 34 being as set forth above, it is important that there be a differential between the coefficients of friction to permit proper feeding of the material 36. The differential of the coefficients of static friction should be at least 0.5. A smaller differential between the coefficients of friction can lead to inconsistent feeding of the material 36, depending on the type of material being accommodated by the feeding system 10.

The flexible platen 12 is semi-rigid, in that it provides upward force to permit contact between the material 36 and the outer surface 34 of the drive roller 14. The flexibility also accommodates variations in the depth dimension of the material 36 without damaging the material as it is being fed. As little upward pressure as possible is exerted by the platen 12 against the material 36 sandwiched between the drive roller 14 and the platen 12 as the material is being fed.

While the invention is particularly useful for feeding difficult web and sheet materials such as bubble wrap, foam, layered cloth and paper, and incompressible papers and plastics, with or without adhesive backings, it can also be used for feeding conventional sheet materials which can be fed by conventional double roll feeders. Various changes can be made to the invention without departing from the spirit thereof or scope of the following claims.

What is claimed is:

1. A feeding system for difficult web and sheet materials, comprising
a. a flexible platen having a low friction transport surface,
b. a drive roller having a high friction surface and being spaced from the transport surface, forming a gap,
c. means for adjusting the gap, and
d. means for operating the drive roller to advance web and sheet materials between the drive roller and the transport surface.

2. The feeding system according to claim 1, in which said transport surface has a first coefficient of static friction and said high friction surface has a second coefficient of static friction, said coefficients of static friction differing by at least 0.5.

3. The feeding system according to claim 2, in which said coefficients of friction differ by at least 1.0.

4. The feeding system according to claim 1, in which said transport surface has a coefficient of static friction of from 0.04 or less to about 0.25.

5. The feeding system according to claim 1, in which said high friction surface has a coefficient of static friction of greater than about 0.75.

6. The feeding system according to claim 1, in which said high friction surface is compressible.

7. The feeding system according to claim 1, in which said adjusting means comprises a screw adjustment.

8. The feeding system according to claim 7, in which said screw adjustment comprises a pair of individually adjustable screws on opposite sides of said platen.

9. The feeding system according to claim 8, in which said screws are mounted in a frame for the feeding system and engage a platen support.

10. The feeding system according to claim 1, in which said operating means comprises a motor connected to rotate said drive roller.

11. A feeding system for difficult web and sheet materials, comprising
a. a flexible, semi-rigid platen having a low friction transport surface having a first coefficient of static friction,
b. a drive roller having a high friction surface having a second coefficient of static friction, said drive roller being spaced from said transport surface, forming a gap,
c. said coefficients of static friction differing by at least 0.5, and
d. means for operating the drive roller to advance web and sheet materials between the drive roller and the transport surface.

12. The feeding system according to claim 11, including means for adjusting said gap.

13. The feeding system according to claim 12, in which said adjusting means comprises a screw adjustment.

14. The feeding system according to claim 13, in which said screw adjustment comprises a pair of individually adjustable screws on opposite sides of said platen.

15. The feeding system according to claim 14, in which said screws are mounted in a frame for the feeding system and engage a platen support.

16. The feeding system according to claim 11, in which said first coefficient of static friction is from less than 0.04 to about 0.25.

17. The feeding system according to claim 11, in which said second coefficient of static friction is greater than about 0.75.
